(19) United States
(12) Patent Application Publication
(10) Pub. No.: US 2004/0153453 A1
(43) Pub. Date: Aug. 5, 2004

(54) Business method for providing one or more functions to react to an alert and reach appropriate sites or people

(75) Inventors: Carolyn A. Brodie, Briarcliff Manor, NY (US); Ernest Legrand, New Rochelle, NY (US); Maroun Touma, Redding, CT (US); Charles Philippe Tresser, New York, NY (US); Catherine Gody Wolf, Katonah, NY (US); Steven Garret Woodward, Paris (FR)

Correspondence Address: DAVID AKER, 23 SOUTHERN ROAD, HARTSDALE, NY, 10530, US

(73) Assignee: International Business Machines Corporation, Armonk, NY

(21) Appl. No.: 09/971,793

(22) Filed: Oct. 5, 2001

(51) Int. Cl. G06F 7/00

(52) U.S. Cl. 707/10

(57) ABSTRACT

A business method is disclosed that uses a new type of alert system, with push technology, and furthermore provides one or more necessary tools for a user to respond to the alert. Some of these tools may include collaboration, access to web page, computational tools, dictionary, search results, translation tools, etc.

### FIELD OF THE INVENTION

This invention relates to information propagation systems. More specifically, the invention relates to a business method for reacting to alerts in information propagation systems, in particular by creating links to appropriate web sites and people.

### BACKGROUND OF THE INVENTION

The Internet has turned out to be an important new medium of communication between businesses of all sorts and their customers, partners and employees. In particular, the Internet:

supports tools for Customer Relationship Management (CRM),

allows to provide customers with marketing material, etc.

More specifically, alert systems on the Internet have proved to be useful tools for several aspects of business support. For instance:

Ÿ Alert systems based on the Internet are of great value as tools for CRM, as they allow marketers to easily provide information important for the customer's benefit.

Ÿ As far as Internet based tools for marketing, alert systems have been proposed as an alternate method to e-mail, preferable to e-mail, because the messages will be reachable from the desktop, thus more easily and directly. Also the messages can be drawn to the customer attention:

Ÿ either in a less invasive form (for instance in the form of a small icon, or a button on the task bar) than e-mail would allow,

Ÿ or in a way that cannot escape the customer's attention (for instance in the form of a popping out window) than e-mail would allow.

Ÿ Alert systems can indeed as well be used for other forms of the relation of a business with its employees and/or customers. In particular forms of commercial relation such as:

Ÿ procurement,

Ÿ urgent messages that would be most probably left unnoticed if sent otherwise,

Ÿ for communications between one part of the business and others, etc.

may be enhanced or facilitated by using alert systems.

For clarity, let us make explicit here that in this text, the word alert refers to what is sent to end users, even if the content has no particular emergency, since the overall technology does not depend on signification. We will use words such as event or content to designate elements of information that may form all or part of the message carried by an alert.

As a method used to reach different sorts of end users, alert systems both allow to transmit the right amount of information at the right time, and, depending on the application, can either present the alert unobtrusively, to the contrary, call very explicitly to the end user's attention. Some alert system allow the users to respond to the server that creates and pushes the alert.

### DESCRIPTION OF THE PRIOR ART

Alert systems are part of what is called push technology, where one of the main arts is to provide content with minimal latency at the user's end, and minimal impact on the traffic on the network being used. Push technology for instance in the form taught in U.S. Pat. No. 6,123,737 to Sadowsky, has in particular been used to develop alert systems such as commercialized, in particular under the name of BackWeb, and serves as basis to various functions such as executive communication, call centers, direct sales, resellers communication, field service, supply chain management, and business to consumer communication (see BackWeb; A Cooperative Architecture for a Flexible “Push-Pull” Broadcasting Solution, March 1997, USA, published on the World Wide Web and http://www.backweb.com). Solution, March 1997, USA, published on the World Wide Web and http://www.backweb.com).

An alert system is a piece of middle ware which has both server side and client side components. Assume the overall system has been installed, and that the server S wants to alert clients C1, C2, . . . , C3, which have been chosen as target of the current alert by human or automatic means. According to the basic principles of push technology, to minimize the time the clients Ci will have to spend in front of their screens, some or all of the content of the alert will be pushed to the clients before they are notified of the alert. The alert then manifests itself by a pop out window of some appropriate size and shape appearing on the clients screens, or as a more discreet mark so that the alert window pops out only if prompted. The window immediately presents a short abstract of the alert content, and/or delivers some information that needs to be used, for instance in the context of using the system for supply chain management. As discussed previously, such a system may serve for several purposes.

### SUMMARY OF THE INVENTION

An object of the present invention is to present a new type of business method using an alert system, also using push technology, but furthermore enriched by also providing one or more necessary tools for a user to react to the alert. The business method uses a combination of push, pull, and collaboration technologies. Some of the tools provided to the user may include collaboration enabling systems in particular with experts on the subject matter of the alert, definition of some virtual community whose members can help respond to the alert and become easy contacts at least during the time needed to respond to the alert, access to web page, computational tools, dictionary, search results, automatic translation tools, etc.

In one preferred embodiment, the invention is used to reach customers or potential customers in a manner allowing enrichment of the contact if and when the customer or potential customer so requires.

For easy reference in the below description, an enriched alert system build according to the present invention will be called ContactPoint.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 represent a generic computer screen before a ContactPoint alert kicks in.

FIG. 2a represents the same generic computer screen as in FIG. 1, after the ContactPoint windows pops out.

FIGS. 2b-2c show a ContactPoint alert manifested by a blinking button.

FIGS. 2d-2g show a ContactPoint alert manifested by a partitioned button that grows, where different parts of the button offer different options.

FIG. 2h is a flow diagram for how the client part of ContactPoint decides to alert the server that the end user does often open the alert messages.

FIG. 3 replicates FIG. 2a, with a magnification of the ContactPoint window, where one can see examples of buttons allowing actions to be taken.

FIG. 4 illustrates one example of tool offered by ContactPoint: after clicking on a chosen button from the ContactPoint window, one is directly connected to a web page, which possibly would need complicated access procedure otherwise.

FIG. 5 is a block diagram representing the overall architecture of ContactPoint.

FIG. 6 is a block diagram representing details from a part of the overall architecture represented in FIG. 5.

FIG. 7 represent examples of various element constituting the content of alerts and response tools in the case of an alert system watching stock price.

FIG. 8 is a flow chart describing, in the context of FIG. 7, how to compose alert and response tools messages for various customers depending on the event and the customer profile, and how to prepare the scheduling priority for the delivery of the message.

FIG. 9 is a block diagram representing the general simplified architecture for a reaction enabling system such as ContactPoint, and various players in the present invention.

FIG. 10A is a block diagram showing how access to extended services can be proxied through the ContactPoint Content Server.

FIG. 10B is a block diagram showing how access to extended services can be made available directly to the client without the use of special proxies.

### DETAILED DESCRIPTION OF THE PRESENT INVENTION

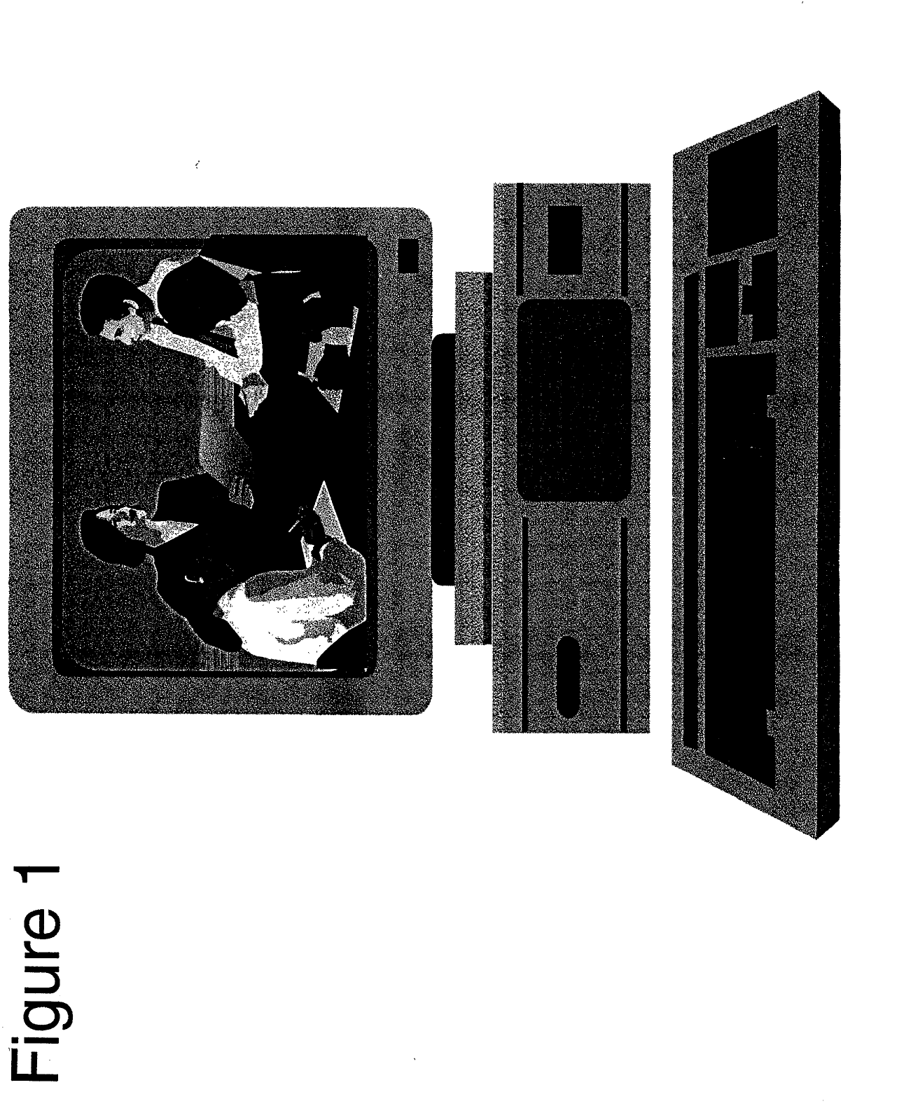

The way ContactPoint is embodied and will manifest itself to an end user, working for instance on a Personal Computer (PC), can be described as follows, with reference to FIGS. 1 to 4.

Ÿ On FIG. 1 is represented an arbitrary screen 100 the user is seeing on the PC, while at work or at play for instance.

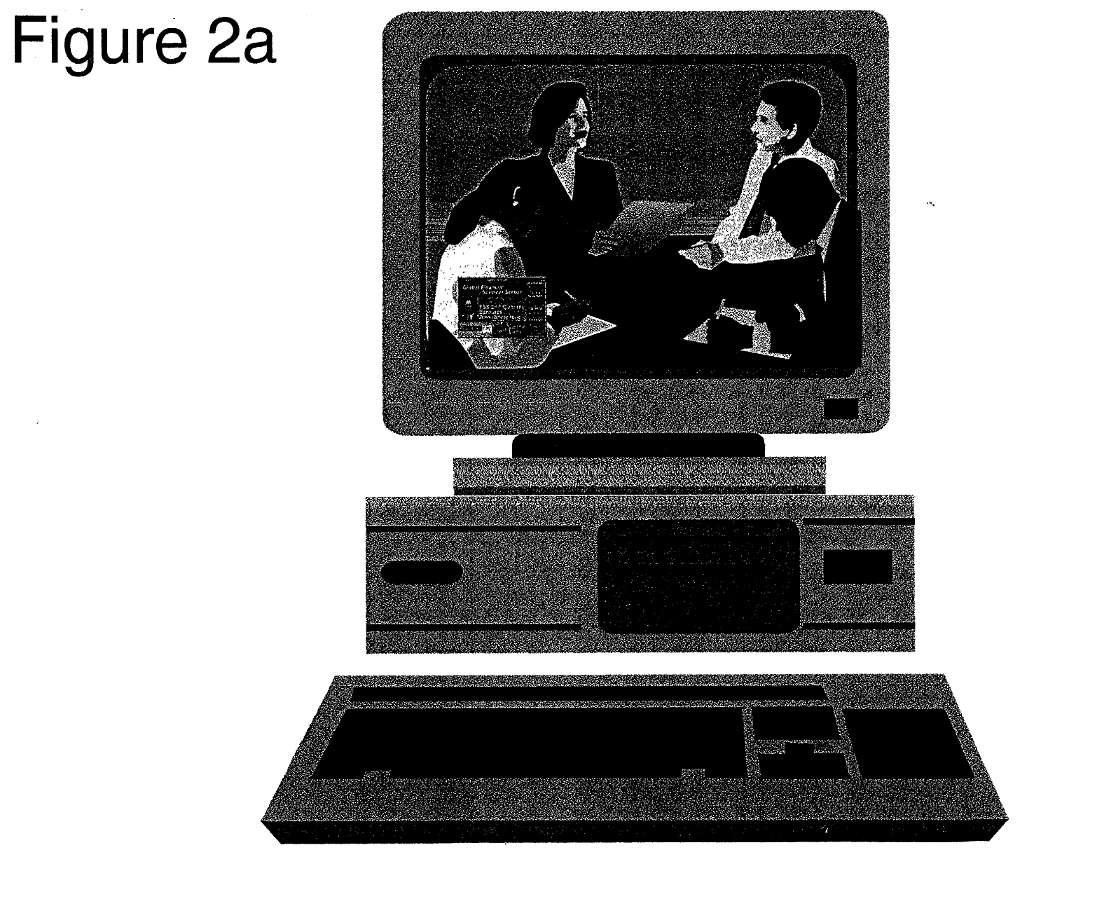

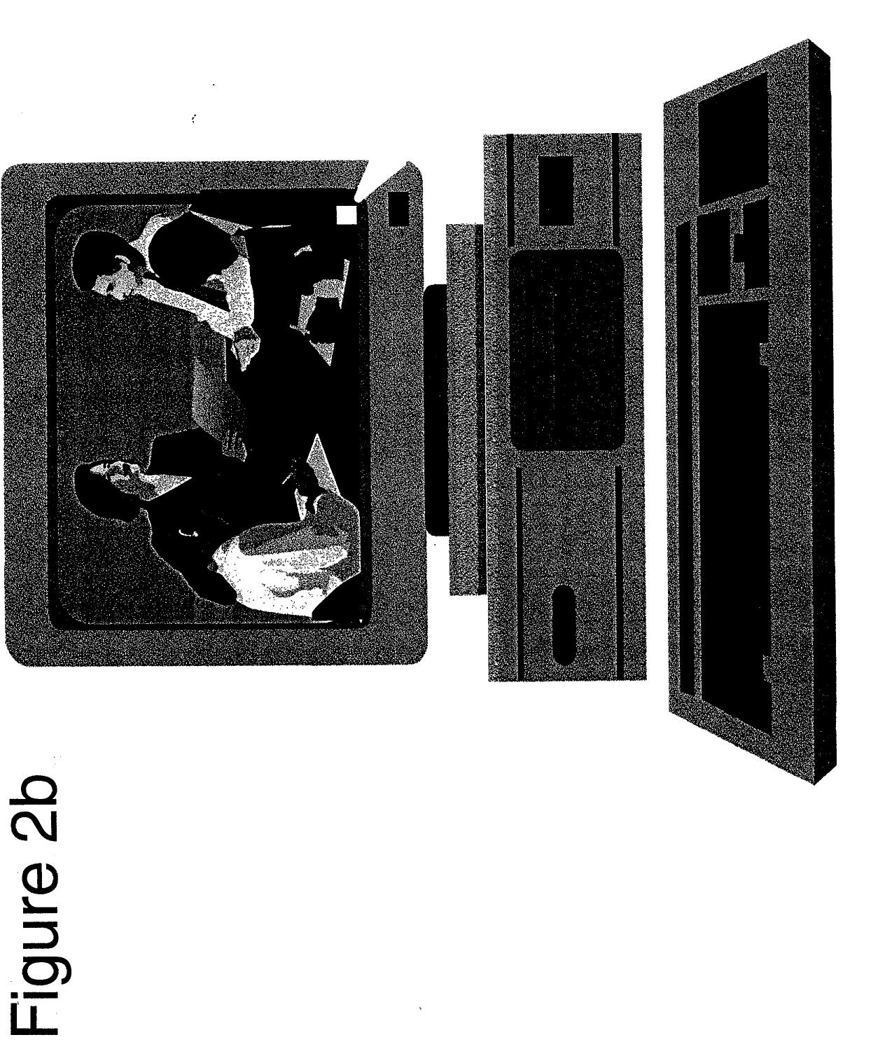

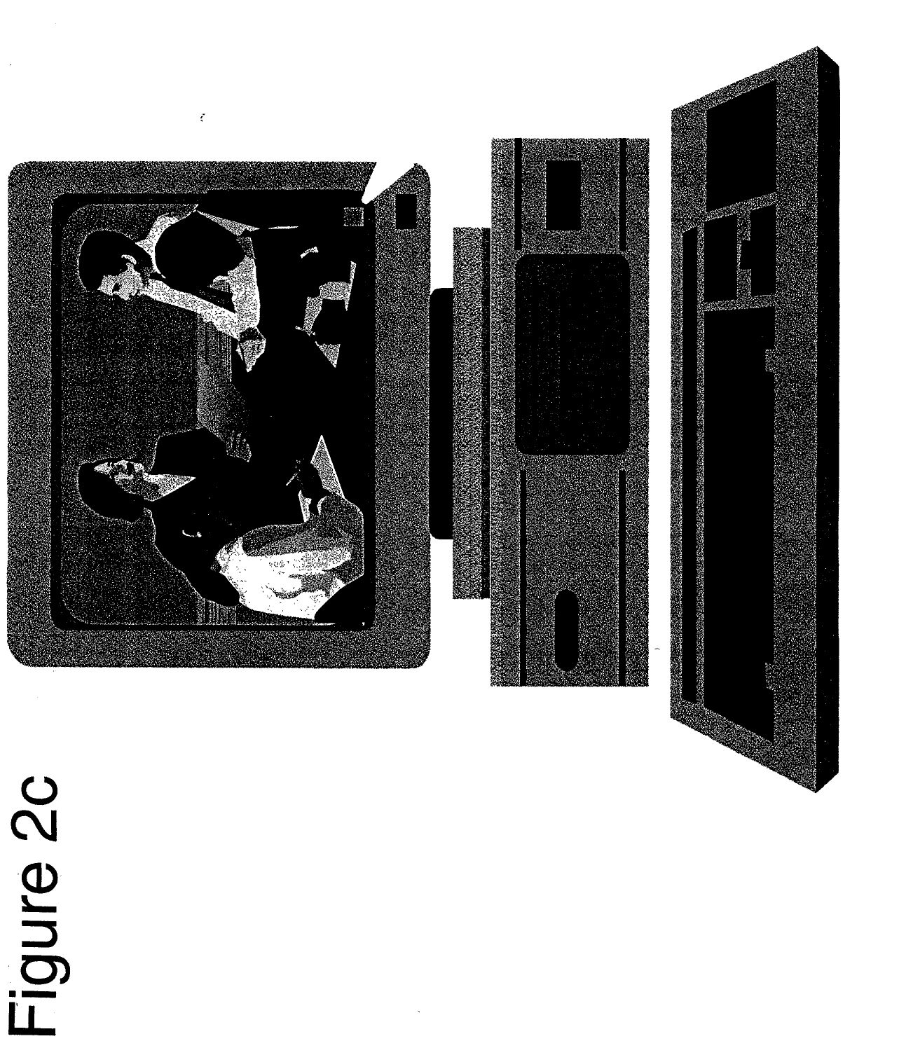

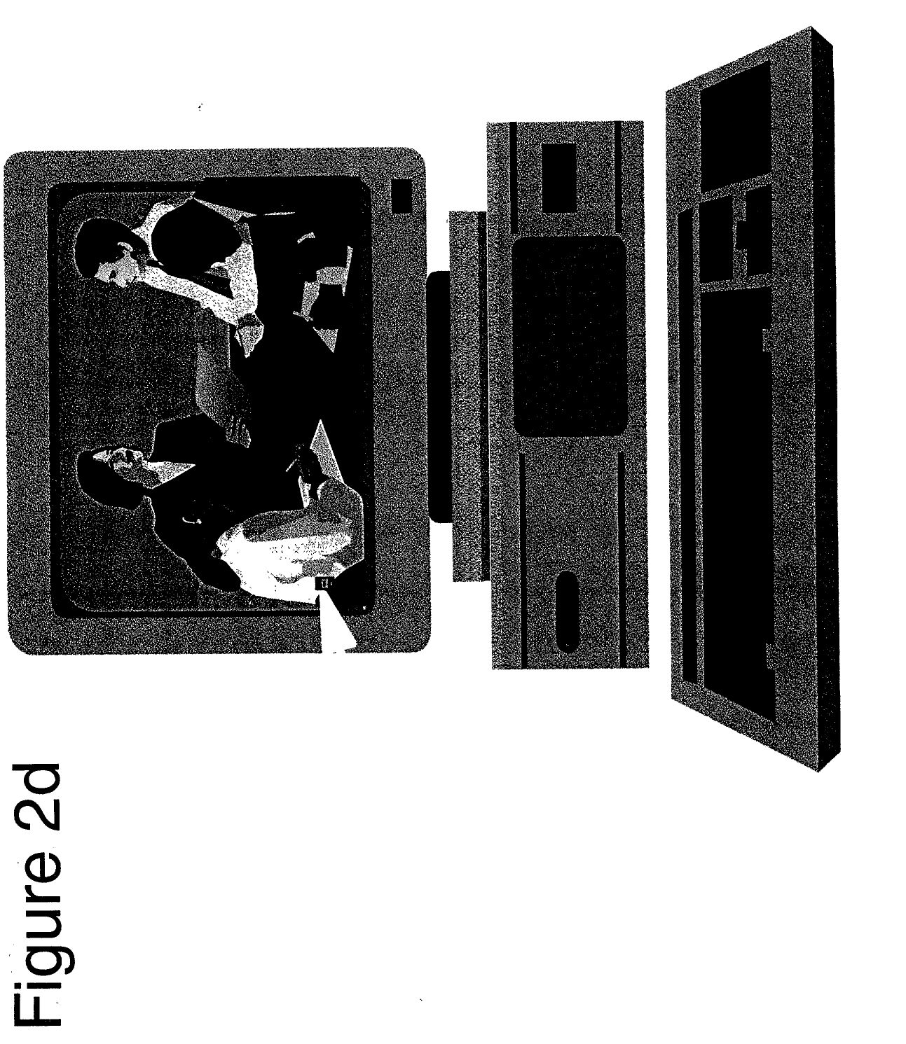

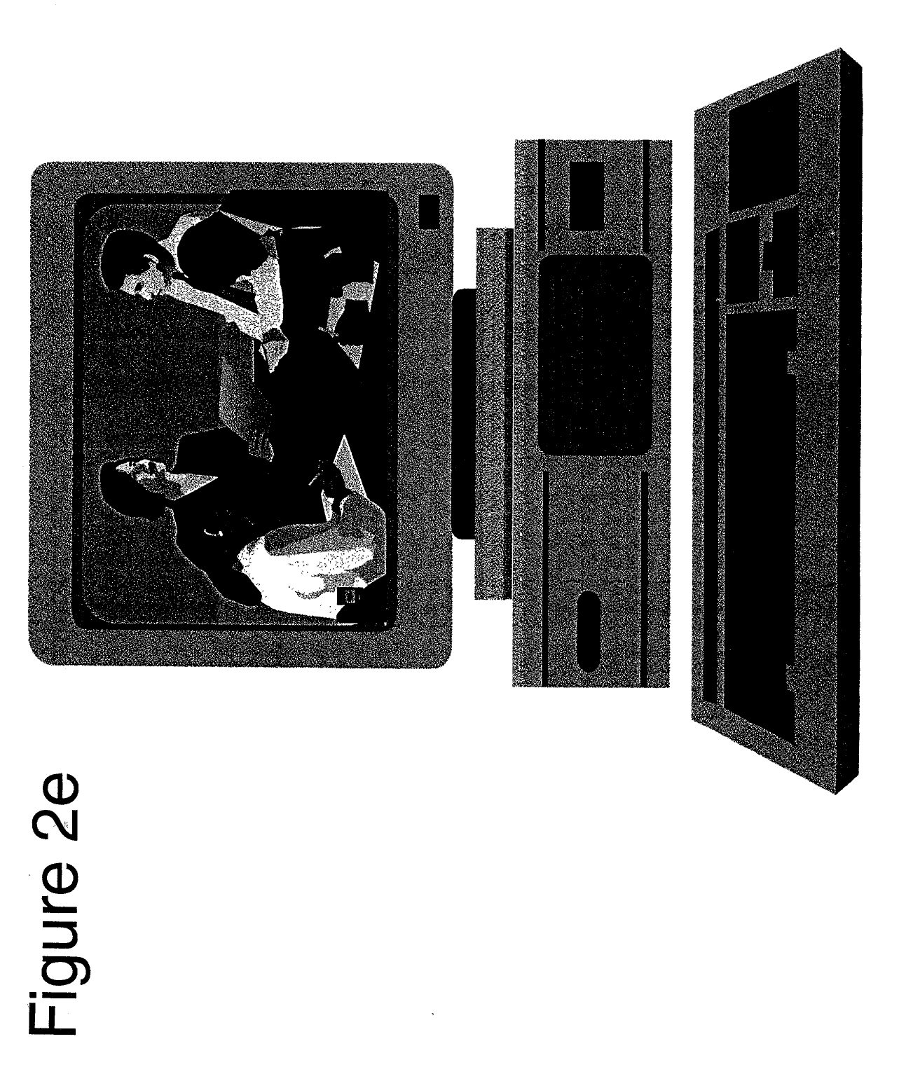

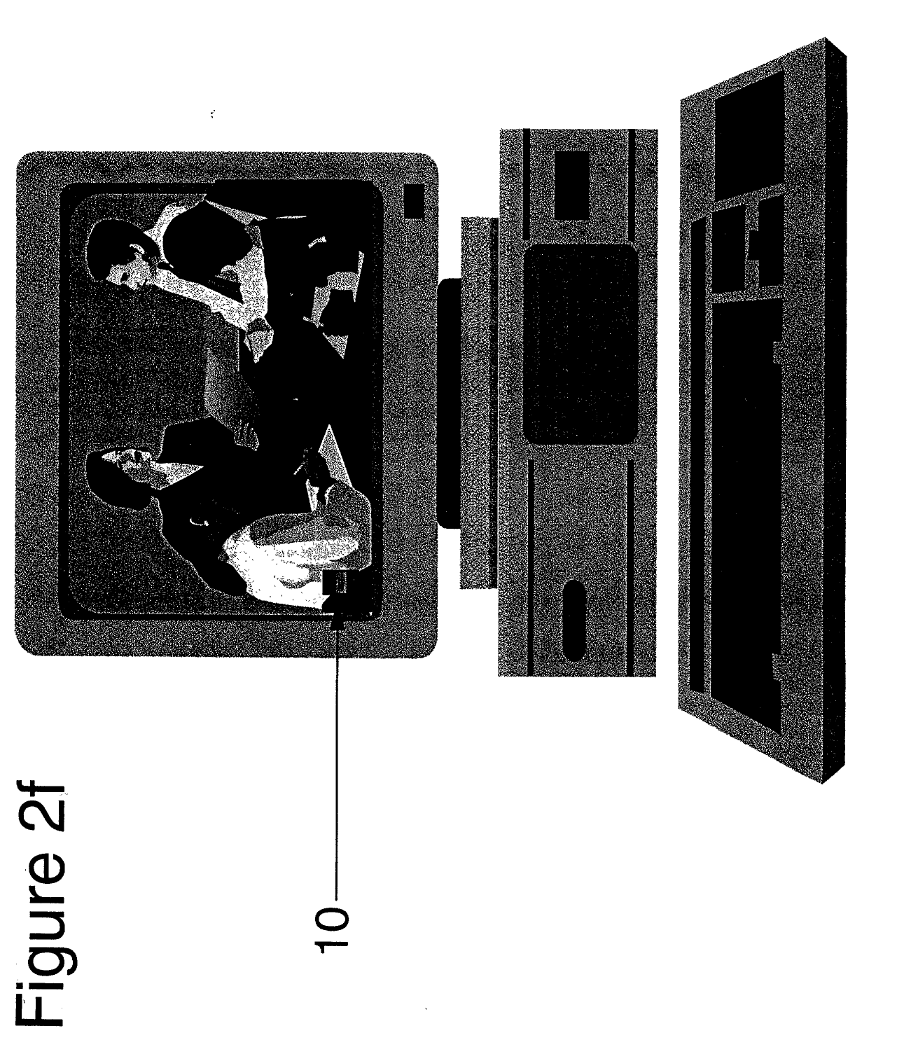

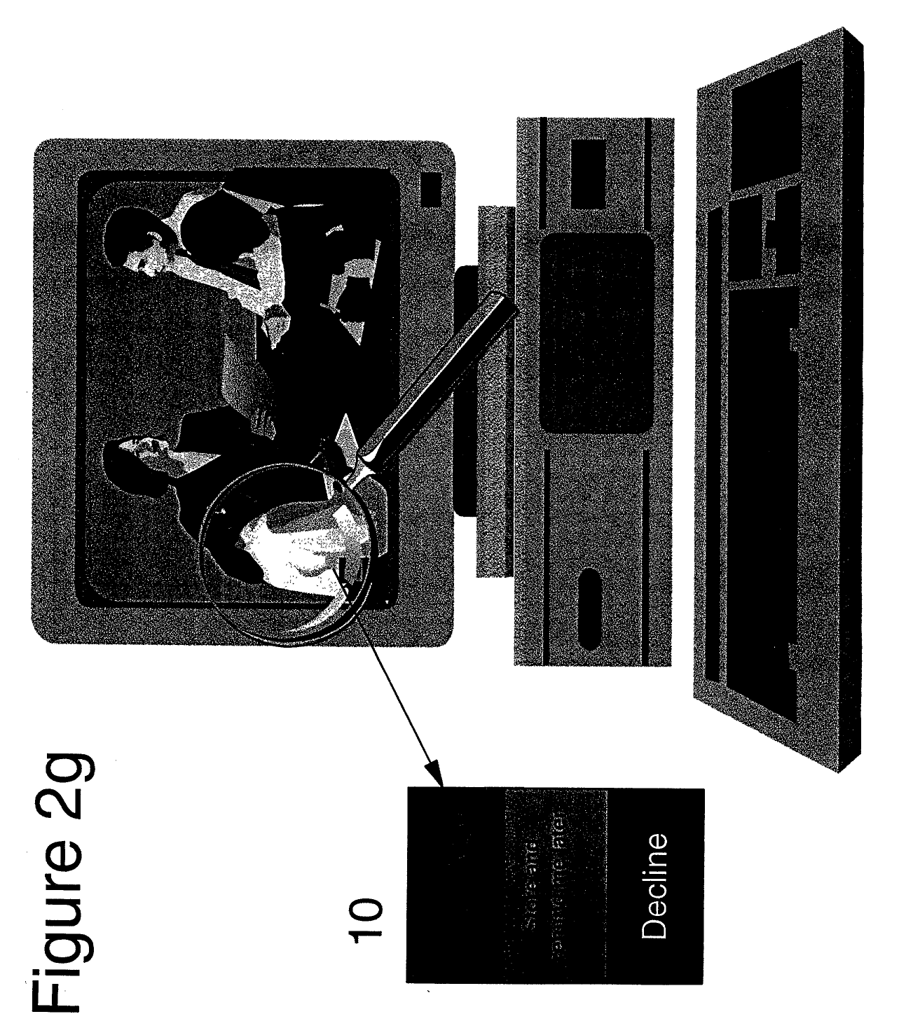

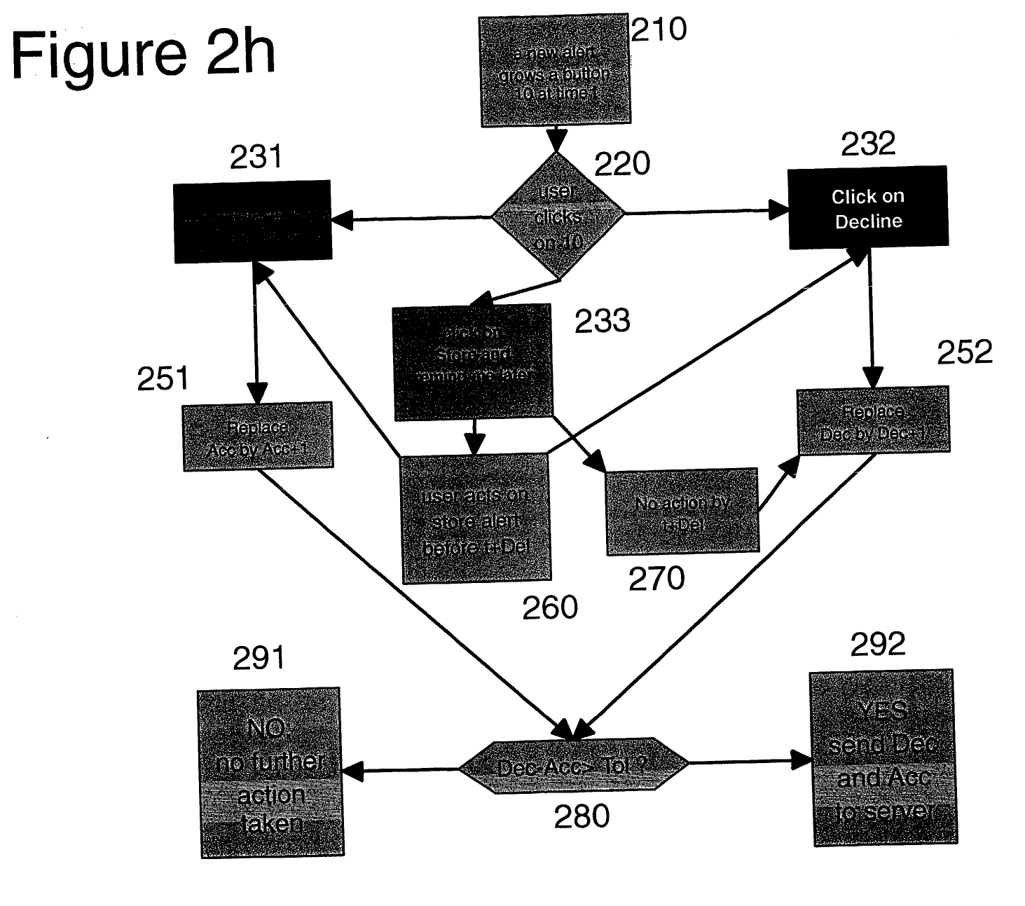

Ÿ On FIG. 2a is illustrated the fact that, without changing the rest of what is on screen, a ContactPoint alert window 105 appears on the screen. Alternatively, a small button 110 could blink or change color 115, and the alert window would pop out only when some button or icon is clicked on (see FIGS. 2b-2c), or a button can grow 120 that offers several options (see FIGS. 2d-2g). The notification modality is not limited to the visual and could also include other modalities such as auditory and tactile, and combinations thereof.

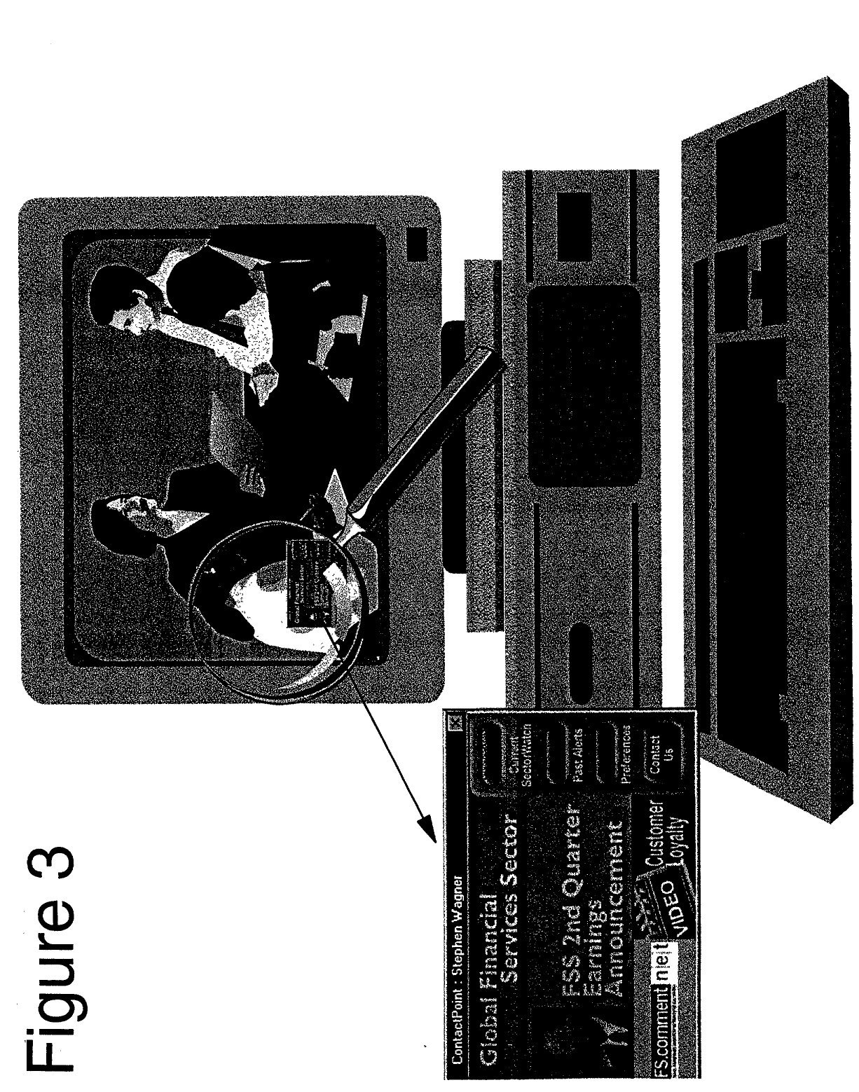

Ÿ On FIG. 3 is illustrated the fact that the ContactPoint window, typically 300, also brings with it 300 means to follow up (typically 350) on the alert. These means are for instance in the form of buttons (typically 360) which allow a variety of actions, whose list will depend for instance on the nature of the alert, and on the type of subscription to ContactPoint of each customer.

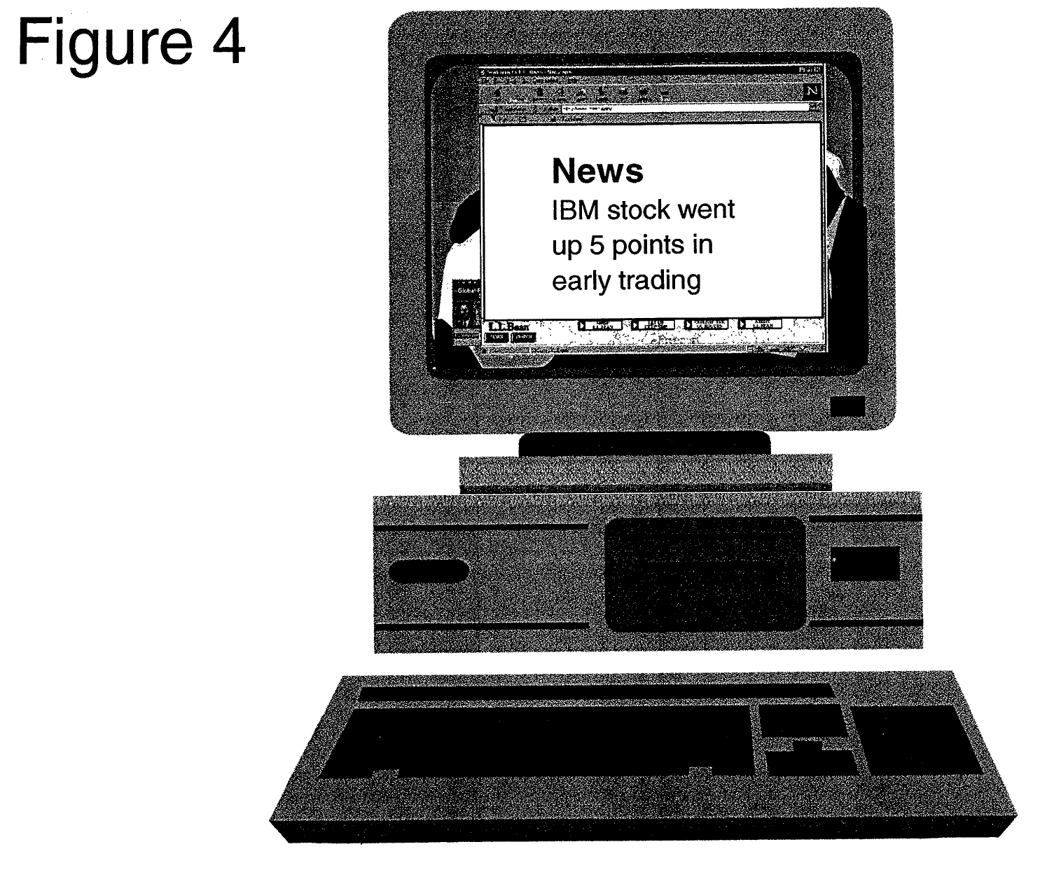

Ÿ On FIG. 4 is illustrated the fact that, by clicking one of the button of the ContactPoint window 400, the end user accesses a web page that possibly would otherwise require some password and subscription. Another button may open some chat session or some audio or video link, etc.

Altogether, such scenarios as indicated with reference to FIG. 4 indicate that ContactPoint is designed not as a simple alert system as currently widely used, but rather as an alert and reaction (and/or collaboration) enabling system, with further reaching capabilities than what push technology as used in prior art would allow.

ContactPoint like other alert systems, has a server and a client part. The difference with prior art comes in the structure and in the functions enabled these two part. The server part of ContactPointencapsulates all information that may be relevant in providing a personalized service. This includes a description of each customer's account and contact information as well as tools that make it easier for the customer to evaluate his account portfolio (for instance in the case of financial services), submit transactions, contact a customer service representative, receive timely updates, be aware of issues that are directly relevant to his ongoing relation with the business, etc. The client part of ContactPoint takes care of the user interface for alert display and reaction enablement, and of the communication with the server. Both the server and the clients part will be described in detail below.

According to the present invention, the same window where alerts will be displayed will also offer the clients the possibility to react to the alert by many means which depend on the alert. Further windows may easily be opened as well (without changing anything else in the overall system and method) instead or in concurrence to special function buttons as displayed in FIG. 3. Examples of what can be offered to the clients to allow them to react to the alert comprise:

1. Software made available which allows the user to evaluate the situation described by the alert. For instance:

i. Calculators

ii. Dictionaries,

iii. automatic language translation tools,

iv. any other special programs will be delivered to compare the merits of two loans offers, to compare different sources of information describing some event, etc.

2. Pages of the World Wide Web (WWW) with protected access will be made available, by a single or a few clicks, possibly avoiding the client's need to register to these pages,

3. Phone connections can be established by a simple click, using for instance voice over IP technology; dual audio and video links can be invoked instead,

4. Collaboration with machines and/or human agents from the server's organization or allies, as well as from the same pool of users and/or community if deemed appropriate (as for instance for some use in the health industry), can be establish by simple clicks. For instance, ContactPoint will enable a community of interest for each end user, that depends on who is the end user and what is the alert, such as creating a group of all doctors that are both subscribers and specialized in the same disease,

5. Any service accessible through a computer link can be delivered to the customer such as a catalog or some order forms to enable procurement: the system will also preferably only deliver catalogs and order forms whose access is compatible with the clearances of the client. In the case the end user is a potential provider instead of a customer, the system can similarly propagate Requests For Quotes, etc.

Notice that single or few clicks as described above could indeed be all replaced by natural language interaction, which can be run from a keyboard, or using speech recognition technology, or a combination thereof.

When using the above defined functions 1 to 5 of ContactPoint as a marketing tool, it will be important to not invade the privacy of the clients nor disturb their work. In fact, except possibly when the marketing relation will involve sending alerts to customers about important events, it will be important for the “message for you” warnings to have minimal impact. For instance,

Ÿthere may be a small button in permanence on the desktop, that will flash and/or change color when there is a new message waiting that has not been seen by the addressee (see FIGS. 2b-2c), Or

Ÿa button may grow (see FIGS. 2d-2g) from the size of a few pixels to some fixed (preferably) small size. For instance, clicking on the grown button 10 in different ways can:

ŸEither open the message,

ŸOr decline access to the message,

ŸOr store it for later, or request the message to be opened and the interaction to begin. depending on which part of the button is selected, and/or on whether the button is clicked after reaching full size or not. In the case when the “decline” option is chosen (or chosen too often), one may prefer that a message signal be sent to the server (to the extent this is compatible to the privacy rules and/or standards used by the ContactPoint owner; indeed, under the same basis, a variety of behavior could be extracted from the ContactPoint usage by the end user, in order to be used for CRM): if several messages are declined, the customer will then be contacted to verify his/her level of satisfaction.

We describe now a decision process to alert the server of infrequent alert openings by some end user. When the client part of ContactPoint is installed at the end user device, the number of alerts that have been accepted Acc is initialized at zero, as well as number Dec of alerts that are declined. The ContactPoint operator decides on a delay Del after which alerts are considered as declined if not opened, and a tolerance Tol on the difference Dec-Acc prompting to send a warning to the server (other trigger methods could as easily be implemented, such as monitoring only Dec). If Del and Tol are changed, the new values will be sent to all end user Contact Point client parts.

FIG. 2h is a flow diagram for how the client part of ContactPoint decides to alert the server that the end user does often open the alert messages.

With reference now to FIG. 2h, a new alert reaches the client at 210 at time t. As soon as the button reaches some size, the user can click the button at 220. The click can send either at 231 (open), 232 (decline), or 233 (store and remind me later). Preferably, not clicking the button before some delay will be interpreted as clicking the “store and remind me later” option and send at 233. From 233, either some action is taken before t+Del at 260, sending either to 231 or 232, or time t+Del is reached at which or after which, the alert is considered as neglected at 270.

From 231, Acc is refreshed to Acc+1 at 251,

From 232, Dec is refreshed to Dec+1 at 252,

From 270, Dec is refreshed to Dec+1 at 252.

From either 251 or 252, one compares the refreshed value of Dec-Acc to the tolerance Tol at 280. If Dec-Acc is smaller than Tol at 291, no further action is taken. Otherwise, at 292, a message is sent to the server to warn on the low acceptance rate of the end user; for instance by Acc and Dec are sent.

To the contrary of what has been described previously in terms of protecting the privacy of the end user in some applications such as marketing we focus now on professional environments such as the very busy environment of a trading room. In trading rooms, very often managers complain about the fact that they have problems calling the attention of the traders reporting to them, even when urgent situations occur. For use as an alert system in such an environment, the ContactPoint window would pop out to insure that the attention of each targeted trader is immediately called by the alert, so that all traders can respond promptly, using the tools ContactPoint will deliver to them at the same time as the alert.

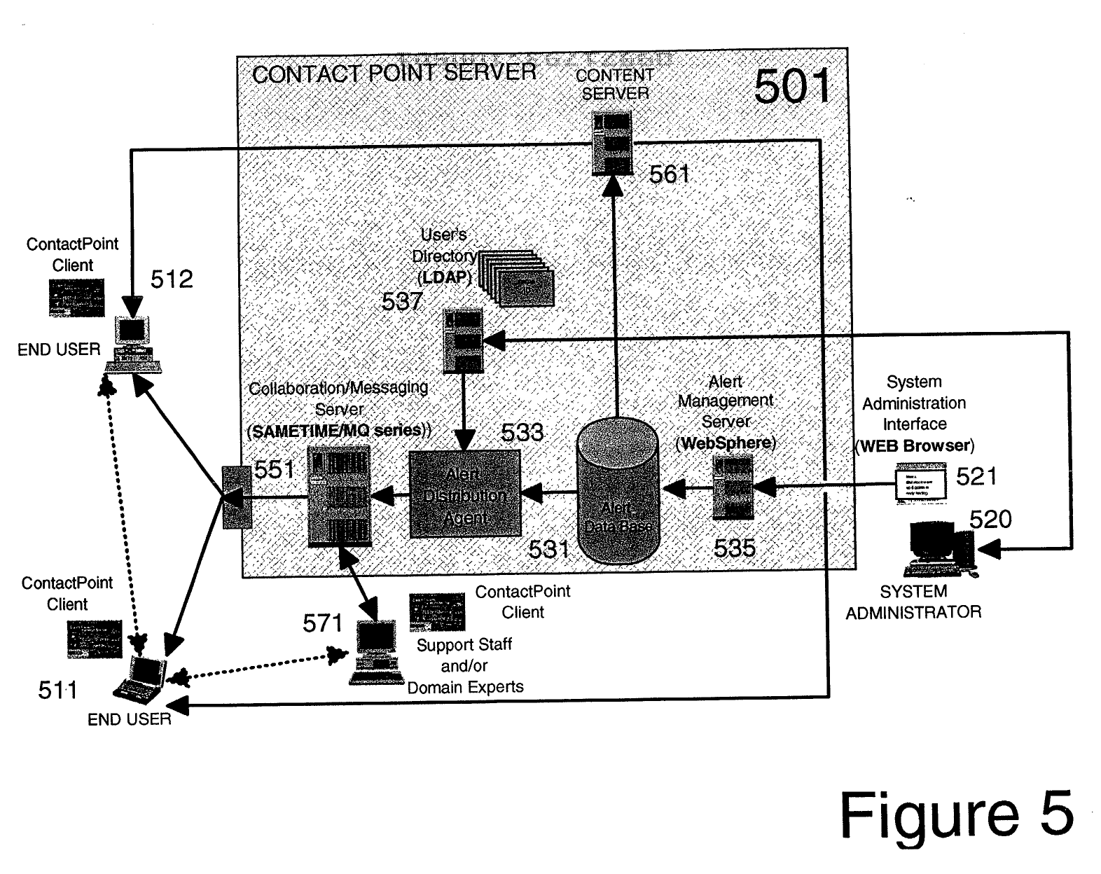

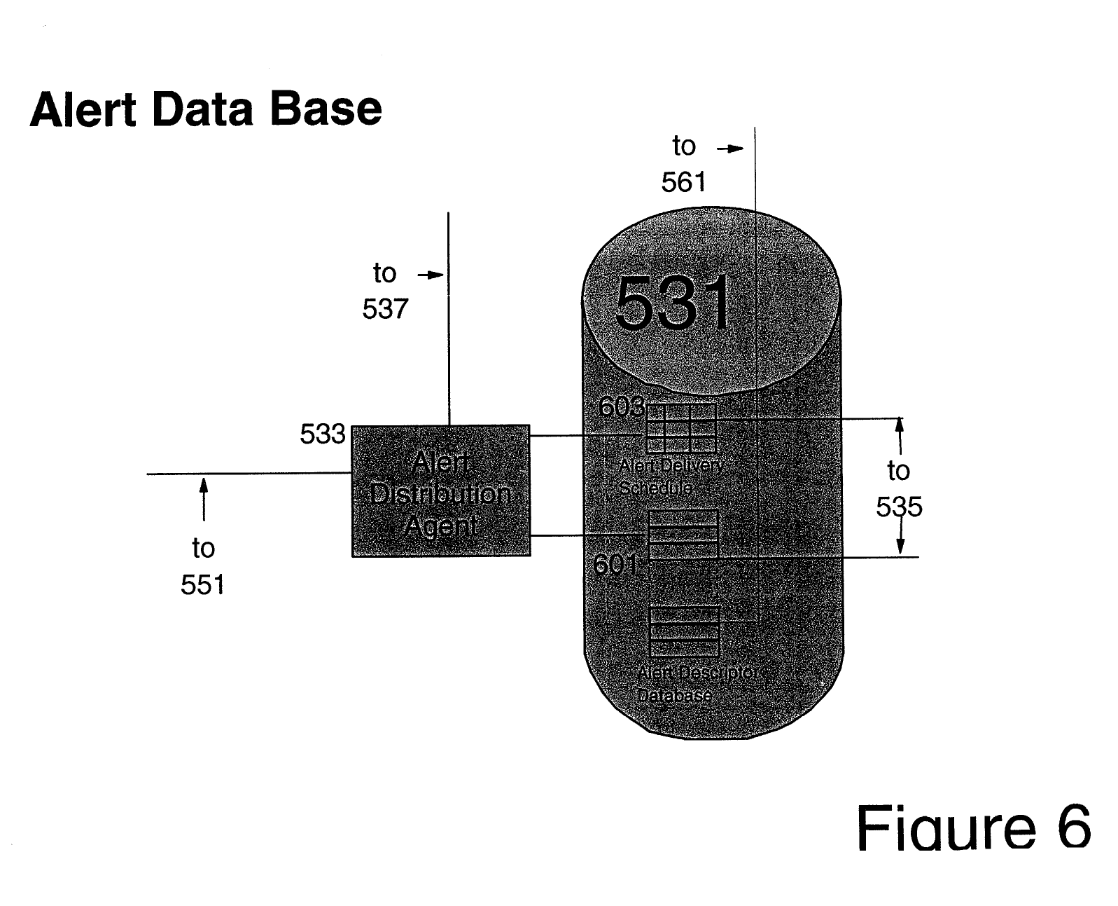

Turning now to FIGS. 5 and 6, a detailed description of preferred embodiments for the system architecture of ContactPoint according to the present invention will be described.

With reference now to FIG. 5, a preferred embodiment of the ContactPoint system comprises the ContactPoint Client at 511, 512 and 571 and the ContactPoint Server (that may comprises the Collaboration/Messaging Server at 551, the Users Directory at 537, the Content Server at 561, the Alert Management Server at 535, the Alert Database at 531, and the Alert Distribution agent at 533) in addition to the System Administration interface at 520 that is mainly used for creating/managing users and alerts. In boldface in FIG. 5 are indicated preferred choices of 520, 535, 537, and 551. Also, one or more teams of Support Staff and/or Domain Experts at 571 and/or facilitated contacts between customers/end users and 571 (see the dotted arrow between 511 and 571), and/or facilitated contacts between customers/end users as part of a community (see the dotted arrow between 511 and 512) will be part of the overall organization to offer all advantages of the reaction-to-alert function. Notice that the dotted arrows represent interactions which indeed will generally be mediated by the Collaboration/Messaging Server at 551.

The ContactPoint client (at 511, 512, and 571) is an application that runs on the end users device (for instance a PC or some wireless device) and manages all users' interactions with the system (Acknowledging/viewing alerts content, submitting queries, issuing transactions, etc.). The ContactPoint client in particular implements the following functions:

1) Logging the user to the server whenever a physical connection is available (this is done in a way that is transparent to the user),

2) Interfacing with the messaging system for receiving alerts and related content,

3) Replicating and locally managing the alert content,

4) Creating the necessary effect for alerting the user to new events and content,

5) Invoking the proper application for rendering the alert content (the alert content distributed to end users could be in any format supported by the platform the client is running on),

6) Presenting the user with the right set of tools available within the context of each alert (i.e., Customized list of people or subject experts he/she can call or chat with, a customized calendar of events related to the alert, a multiple choice check list indicating the users interest or lack of interest in the article or the product being promoted, standard preferred tools pre selected for each form of alert—also possibly depending on the customer profile, etc.),

7) User virtual identity used for authenticating and controlling access to various servers (and/or functions such as transactions, etc.) when retrieving documents and alert related links from the web or when submitting transactions.

All functions described in points 1, 2, 3, 5, and 6 above are well known and could each be easily implemented by anyone trained in the arts of programming and networking. Function 4 has been described above, with reference to FIGS. 1 to 4, and the corresponding implementation is also known art. The special high decline alert associated to Function 4 has been described above with reference to FIG. 2h. Function 7 is described in the section below entitled “Identity and entitlement manager for electronic commerce applications”.

The ContactPoint Server (at 501) includes:

1) The Alerts Database (at 531) that contains the definitions of the different components for each alert:

i) alert dependent Visual/Audio means to communicate that there is new content when the alert is first received by the user,

ii) the alert priority relative to other alerts in the system,

iii) possibly the URL to the actual alert document (this could be a document on the current server or a remote server on the web),

iv) and the list of users the alert is intended to with the status for each user such as “Pending”, “Received”, “Viewed”,

all items i) to iv) being part of the Alert Descriptor Database at 601 in FIG. 6, as well as v) the Alert Delivery Schedule at 603 in FIG. 6,

2) the Alert Distribution Agent at 533 that manages the distribution of the alerts based on their priority and the user current status (connected or off-line) and possibly the user priority. The alert distribution agent will for instance always attempt to send the latest alert submitted first and re-iterate on the older alerts only after the most recent one has been acknowledged by the seer. Each alert will preferably be stamped with a deadline or freshness date that determines when the alert becomes obsolete and should be discarded if not transmitted by the given deadline. Since the users may not be connected at all time, the alert distribution agent will preferably be able to detect when the user connects to the system and whether the alert was successfully transmitted before the user disconnects from the system. If some user fails to receive too many alerts, according to some predetermined tolerance, a message may be sent to the system administrator, who may then try to contact the end user, or take some other actions.

3) The Alert Management Server (at 535) that implements a set of tools that the System Administrator (at 520) uses for managing user profiles and defining the alerts and the Alert Distribution Schedule. These tools include a web interface for adding users to the system, creating groups of users and assigning users to each group, defining user profiles that will subsequently be used to decide what alert or type of alert a given user or group of users should receive, defining the alert components such as the visual effect the client should produce when the alert is received, the full document of the alert, the alert expiration date, the subject expert assigned to the alert and the most appropriate communication medium (i.e. text chat, voice chat, e-mail, audio/video conferencing, etc.) That the alert recipient can use to start a collaborative session with the subject expert. The Alert Management Server also allows for grouping of alerts so related alerts can be sent simultaneously to provide a more complete view of a particular event. It also provides the administrator with a global view of who receive any particular alert and when and means for defining alert priorities so the delivery of a more recent alert can follow or proceed a previously pending alert.

4) the Content Server (at 561) is a repository of documents that include the main body of the alert and other related documents that need to be replicated to the alert recipient's local environment or local device used for receiving and viewing the alerts. These documents could include links to external documents that do not reside on the content server and therefore are not replicated to the alert recipient's local environment.

5) the Users Directory (at 537) that lists all the users that can log in to the system and their identifiers (IDs). In addition, it preferably includes a user profile that defines the user interest for targeted information and possibly other parameters, such as priorities as defined by the price paid for services, and/or depending on the value of the customer for the ContactPoint operator. The User Directory can be implemented on top of such directory standards as the Lightweight Directory Access Protocol (LDAP) or other directory services.

6) the Collaboration/Messaging Server (at 551) that allows two or more users to engage in real-time collaborative activities such as chat or document sharing. It also implements the messaging protocol since an alert can be viewed as a message sent from an automated user (the Alert Distribution Agent at 533) to the end users (511, 512 and 517), be they customers (like at 511 or 512) or part of the organization (like at 571).

The System Administrator (at 520) is responsible for creating and maintaining the user IDs and the Alerts Database at 531, using for instance a Web Browser as a System Administration Interface at 521.

Databases and a variety of documents production tools can also be part of the tool kit at 520, or integrated with the Alert Management Server (at 535). All of the logic for administering the system is preferably implemented as Java servlets running inside of WebSphere (as an example of server that can support ContactPoint: WebSphere is a product of the IBM corporation), and includes the following functions:

SA1) Creating a new User Id and user profile,

SA2) Creating the alert including the visual effect produced by the client as well as the alert content and priority,

SA3) Associating subject expert at 571 with the particular alert,

SA4) Specifying related link with additional information, and/or actions access and further tools the alert recipient can use to respond to the alert,

SA5) Creating one or a plurality of virtual communities for some or all alerts,

Function SA1) is an administrative function once proper verification that the user qualifies has been made. Such verification can be done in many ways and is rule dependent: for instance every user may qualify, or the user must give some credit card information, or the end user may need to be a regular customer, etc.

Function SA2) can be of varied nature.

Ÿ In one extreme case, alerts are created from analyzing news. Then a news feed will bring news from some sort at 585 to the Alert Management Server at 535. In the case for instance of market data, the type of news that should be isolated as events (which we defined as actual or potential alert contents or alert content components) may be identified automatically. Examples of events are provided by stock prices passing some preset barrier, showing some jumps above some fixed level on or under a preset interval of time. The alert content can be also determined by simultaneous data, or successions of events rather that single data points. Some or all of the parameters that define an event may be fixed differently by different end users, in which case 520 will access 537 to retrieve such user information. The form of the alerts that will be sent can be very uniform, and consist of just the event displayed in some predetermined format, or some rule can be designed where the alerts are chosen depending on classes of events: for instance on the amplitude of a price differential in the case of market data can determine the color of the background of the message. A human agent can either have the means to overrule the automatic decisions, or fully be in charge, depending on the type of business.

Ÿ In the other extreme where the appearance of the alerts is as important or more important than the signification of the events, each alert may be completely composed by human agents which may spend lots of time and money to create content elements such as video-clips and other forms of multimedia content.

Some or all of the functions SA3) and SA4) can be performed automatically, using natural language understanding to recognize how each alert should be handled: in the simplest form, the system would look for key words, and then check a database residing for instance at 520 to match proper responses to these key words. A numeric priority P(A) will also be attached to each alert A, so that if P(A1)>P(A2), the alert A1 has higher priority than A2: we will describe later how this different priorities are handled. The priority can be assigned according to a preset collection of rules. Again, a human agent can either have the means to overrule the automatic decisions, or fully be in charge, depending on the type of business.

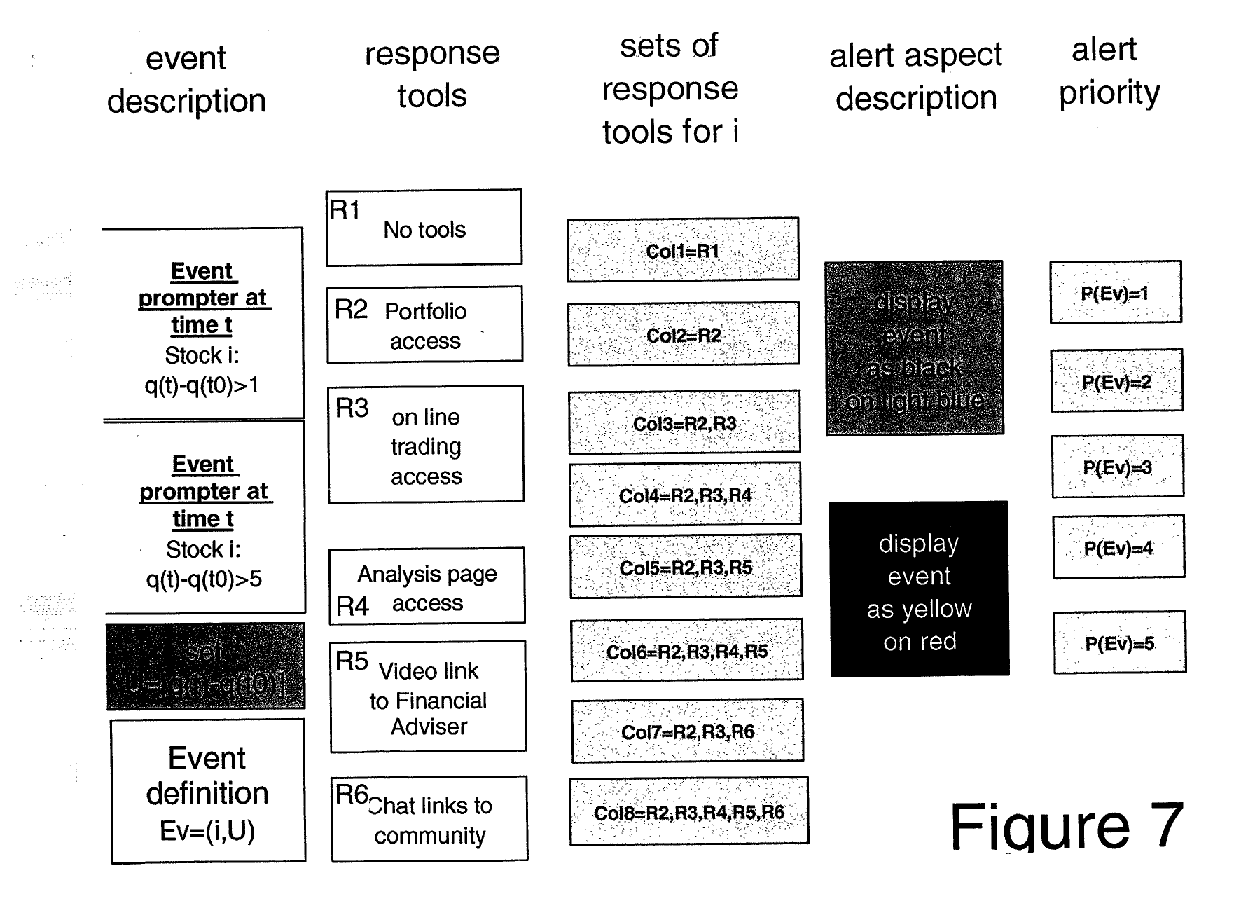

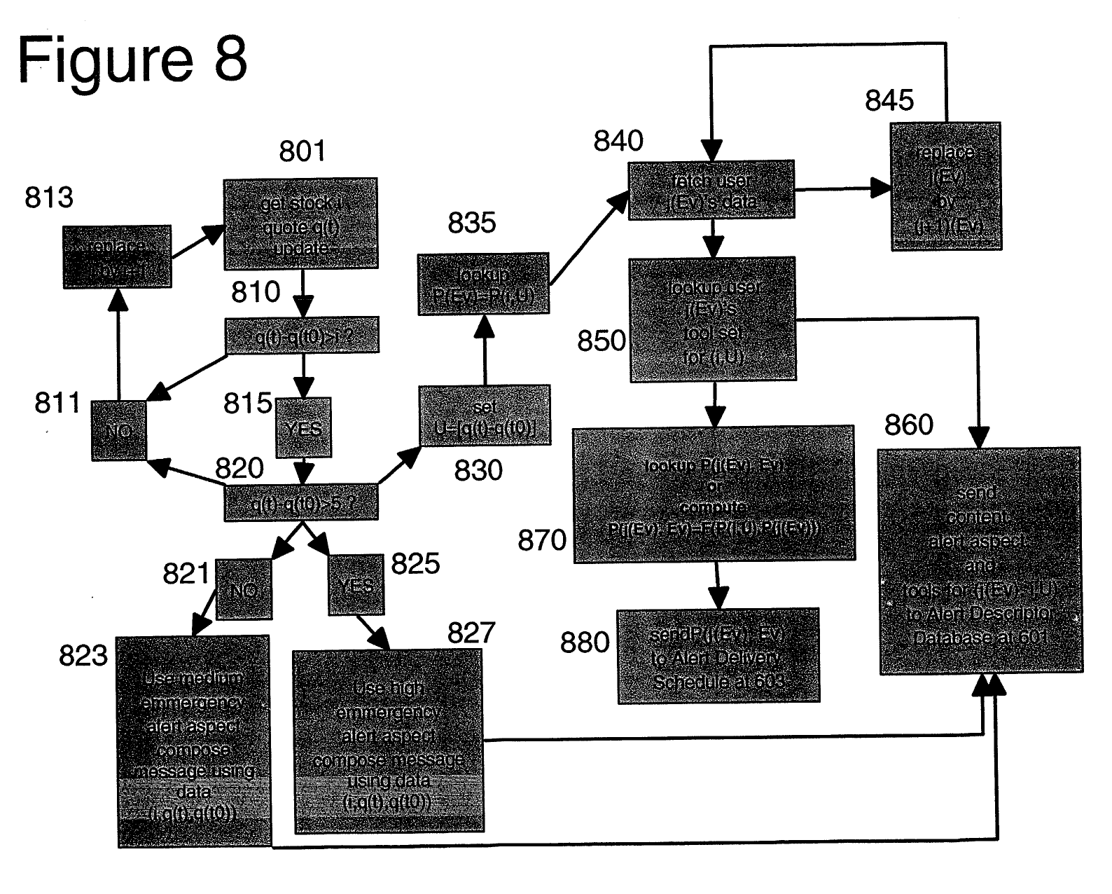

With reference now to FIGS. 7 and 8 we describe in more details how function SA2, SA3, and S4 can be performed automatically in one special case chosen for ease of language: anyone versed in the art would easily adapt what is presented here to other contexts and data structures. With reference first to FIG. 7, in the case of an alert system for stock quotes, some set of events will be defined (to simplify FIGS. 7 and 8, only quote increases are considered, while all elements represented in these figures should have counterparts in the case of stock quote decrease). The database (that can be integrated in the Alert Management Server at 535) will contain:

Ÿ The events prompters associated to stock i, or information that determine there is an event (different types of event prompter may be defined for different stocks, and prompter can be defined by set of stocks), for instance, one may decide there is an event when there is a stock quote differential between present time t and some time t0 that may be chosen as the time of market closing the previous trading day, or the time of opening of the market the current day. Setting U=[q(t)·q(t0)], where [x] stands for the integer part of x, an event may be defined for instance as the pair Ev=(i,U).

Ÿ The elementary response tools which are stock independent,

Ÿ The set of response tools that can be associated to events on stock i,

Ÿ The set of alerts aspects for various events on stock i,

Ÿ The priority P(Ev)=P(i,U) for the alerts on any event for stock i.

With reference next to FIG. 8, we have a flow chart describing how to define alert messages and associated response tool sets, using the elements defined in FIG. 7 and the data from the User Directory at 537.

Some list of stocks designated here by their number i in the list are examined consecutively. At tome t, the quote q(i) of stock i is communicated, for instance by some direct feed ad provided by Reuters or Bloomberg at 801. At 810, q(t)−q(t0) is compared to 1.

If q(t)−q(t0) is not greater than 1 at 811, i is replaced by i+1 at 813, and the system takes care of the next stock, back at 801.

Other wise at 815, the flow continues to 820 where q(t)−q(t0) is further compared to 5.

Then, if the answer is NO at 821, a message displaying (i,q(t),q(t0)) will be prepared at 823 using some preset format adapted to medium emergency level alerts, and possibly depending on i. Otherwise, the answer is YES at 825, and a message displaying (i,q(t),q(t0)) will be prepared at 827 using some preset format adapted to medium emergency level alerts, and possibly depending on i. Whether the answer to question 820 is NO or YES, the integer part U of q(t)−q(t0) is computed at 830. Next, the priority P(Ev) of the event Ev=(i,U) is generated at 835 using a lookup table. At 840, one considers successively all users data who are interested by the event Ev. The tool set that j(Ev) will receive to react to the alert on event Ev is looked up at 850 in the User Directory 537. At 860, the message content and aspect composed at 823 or 827 as well as the tool kit for the triple (j(Ev), i, U) coming from 850 are sent to Alert Descriptor Database at 601. The way the priorities are decided at 870 and 880 will be described below in the section on scheduling. In parallel to the event at 860, 870, 880, or after the three functions have been taken care of, j(Ev) is replaced by (j+1)(Ev) at 845. If j+1 is greater than the number of users interested in Ev, one goes back to 813 to consider the next stock treated. Otherwise, returning at 840, the next user concerned by event Ev begins being treated.

Function SA5) can be fulfilled by looking up the User Directory at 537, or other sources of information, possibly dynamically updated, that the System Administrator may access, for instance from the WWW.

When a new alert is submitted and sets of response tools are associated to it with each set carrying a service level tag, it is immediately stored in the Alerts Database at 531. The Alert Distribution Agent at 533 retrieves the list of alert recipients of the alert being considered and their respective tagged sets of response tools for the alert being considered from the Alert Database at 531 whenever the state of the system changes, for instance:

Ÿ a new user logs in,

Ÿ a new alert is submitted,

Ÿ a previously delivered alert has been acknowledged by the client, etc . . .

It then registers the list of addressees with some collaboration enabling messaging system (such as Sametime [see, e.g., www.sametime.com] or MQ series [see, e.g., www.ibm.com/software/mqseries], both distributed by the IBM Corporation, at 551). The messaging system is responsible for notifying the alert distribution agent if a particular recipient is online or deferring this notification until the recipient logs in to the system.

When an end user next boots up his system, the ContactPoint client determines if it has a network connection. If a network connection is not available at startup, the client suspends itself and wakes up periodically to query the system until it determines that a network connection is available. It then automatically initiates the log-in procedure to the Collaboratio/Messaging Sever at 551.

Whenever the alert distribution system is notified that a particular user is online using the Collaboration/Messaging Sever at 551, it retrieves all the alert descriptors at 601 for the alert including: visual effect (one can for instance use alternating images (e.g., gifs) to produce flashing on the screen), alert document URL (we prefer to support HTML as well as videos), related URLs and other resource the alert recipient can access including a list of subject experts that the alert recipient can contact via telephone, chat, data conferencing, e-mail, video-conferencing, analytic tools, dictionaries, translation machines, etc. The alerts contents and parameters, as well as the response enabling tools parameters are then packaged in one message and sent to the recipient ContactPoint client at 511, 512, and 571 via the Collaboration/Messaging Server at 551. After receiving the message the client retrieves all related documents to the local PC, or other computing device being used (whenever required for off-line browsing) before flashing the alert on the recipient's screen. It then sends an acknowledgment to the Alert Distribution Agent at 533 in the form of a reply message indicating successful (or unsuccessful) reception of the alert.

As described previously, the client could also send an acknowledgment to the server when the user actually clicks on the flashing alert, to the extent this is compatible to the privacy rules and/or standards used by the ContactPoint owner.

When the user clicks on an alert, the proper application for handling the content of the alert (web browser, media player, etc.) is invoked to display the alert. The client then displays the list of users or subject experts in a separate window inviting the user to click on one of the names and start a collaboration session with the particular expert. The end user can also or instead be offered buttons to prompt a variety of responses to the alert, as was discussed previously with reference to FIG. 3.

The alert content or related URLs may reside on web servers across the Internet that may or may not require user authentication. If user authentication is required for some or all accesses, the ContactPoint client handles any authentication in a manner that is transparent to the user, according to what we describe below (see “Identity and entitlement manager for electronic commerce applications”). This is possible by adding the necessary credentials for accessing this information to the user's profile in the ContactPoint users directory server. These credentials are retrieved on-demand by the ContactPoint client and presented to the hosting server when needed. This allows quasi-anonymous access to secure (nonpublic) information as long as the proper authorization are obtained from the hosting organization by the organization offering ContactPoint services. The overall security can also be enhanced by requiring some access methods to be used on the ContactPoint window, such as a password, or some smart card.

We now discuss scheduling. In some cases, there will be too much data to be transmitted in one alert to allow all customers to be addressed at the same time, because of the network limited capacity (for instance, when the alert comprises a video clip). This issue will be addressed by proper scheduling, as we next describe.

The clients being grouped in classes W1, W2, . . . , Wn with priorities 1, 2, . . . , n, where the highest number corresponds to the highest priority, one will first serve the customers with priority n. If Wn has a small enough number of members to accommodate network on a given message, they will all be served at once, together with some members of groups with lower priority. Otherwise, one will pick a subset of Wn for the first round, and proceed in similar manner in subsequent rounds. The choice of the subset can be made at random for each new message and at each round. Preferably, instead, one orders cyclically the members of the class, putting new members at a definite place or at random in the circular line, and one keep memory of which members has been last served with the highest priority to define who will be next. The same method will be used when dealing with lower priority classes.

One can also avoid pushing heavy content such as video, and just send a message allowing to prompt the delivery of any heavy content. The delivery will either be prompted simply, automatically and transparently for the client, by the opening the message. Alternatively, the client will have to choose to receive or not the message. In any of the automatic and decision driven requests cases, the request of the requester R will then arrive to the se rver with the priority P(R) of the requester and the time T(R) when this request is sent (alternatively, T(R) may be chosen as the time when the request reaches the server). The two parameters P(R) and T(R) can then be used to order the sending of the heavy contents to the requesters. In one extreme case, each request keeps the priority P(R) defined by who is the requester R, and the priority supersedes time ordering, so that high priority customers can only be preceded by same or higher priority customers, except if some lower priority customer could put his/her order at a time the file was small and the order could be fulfilled. To the contrary, the priority of a request can increase with time, according to a formula deemed adapted to the weights one wishes to give to priority. For instance, the priority at time T(R)+Dt(R) can be set to P(R)+[Dt(R)], where [X] stands for the integer part of the number X, and the elapsed time Dt(R) since T(R) is measured using some unit, which may depend on the performances of the network at the time of operation, or be fixed, say to one second or one minute. A variety of alternate scheduling methods can be used, as well known in the art of queuing theory: see for instance Leonard Kleinrock: Queuing Systems Volume I: Theory (John Wiley and Sons, New York, 1975), Volume II: Computer applications (John Wiley and Sons, New York, 1976) (see in particular Volume II, Chap. 3, Priority Queuing, pp. 106-155).

The methods we just described to treat requests will be also use to handle the priorities of events Ev, in the case there is no priority set on alert addressees. In the general case, we may assume that when there is a new alert, there will be priorities assigned both to the event Ev, say P(Ev) (or P(A) if one prefers to speak of the priority of the alert A rather than the priority of the event Ev that constitutes the content of the alert) and to the user j(Ev), say P(j(Ev)), this one depending to the class Wk to which j (Ev) belongs for event Ev. With reference now to FIG. 8, using some predetermined function F, the priority P(j(Ev),Ev) of the pair (j(Ev),Ev) is calculated out of the priorities of j(Ev) and of Ev. For instance, P(j(Ev),Ev) can be chosen as the sum of the priorities of the user j (Ev) and of the event Ev. The way the priority P(j (Ev),Ev) is handled can be chosen as has been described previously for requests priorities.

Some examples of “Identity and entitlement manager for electronic commerce applications” are now presented.

One of the reactions to alerts that can be enabled by ContactPoint is easy access to special WEB sites, that we call secure web sites, by which we mean those sites that have complicated access, requiring in particular:

Ÿ subscription

Ÿ and/or passing some access control, using for instance:

Ÿ Passwords

Ÿ and/or encryption (as can be implemented for instance by using smart cards),

Ÿ and/or payment.

Typically, currently, the user of a secure web site has to use a user ID/password or a personal digital certificate to identify himself/herself to some web site servers. There might be situations where the user:

I. does not want to disclose his/her identity,

II. has no time to subscribe to a site useful to respond to an alert,

III. does not wish to pay for a subscription to a site he/she may use only once, etc.

To allow the user to remain anonymous while ensuring security, as well as to overcome other difficulties described by example in the list I, II, III above, the present invention will disclose how ContactPoint, as an example of a reaction enabling system extends the digital certificate to include entitlement of some of its selected users. The user of the web site who requests access to a site as invited to by the reaction enabling system, does not have to disclose who he/she, pay fee, or other inconveniences. The company that owns the web site and is providing the service does no have to be the issuer of the certificate. The issuer may be the company that operates the reaction enabling system server or another company that had forged some sort of partnership with the owner of the web site to provide a specific service for the customer of a reaction enabling system.

For example, a Mutual Fund Firm A may offer its customers a special service to help them prepare their income taxes early in the year. The tax service will most likely be offered by a Tax Preparation Firm B with whom Firm A had negotiated a special contract. Such contract may specify that the offer is only available for the first 4 month of the year and free of charge to Firm A customers. To receive the service, a Firm A customer does not have to sign-up for a new account with Firm B. The simple fact that he is a user of ContactPoint allows him to receive the tax preparation service until such time as his entitlement to the service is revoked by Company A.

Unlike service aggregation (such as online bill payment U.S. Pat. No. 5,383,113: System and method for electronically providing customer services including payment of bills, financial analysis and loans) that requires the user to negotiate his own contract with the firm service providing firm (for example a utility company) and then to enter the parameters of his contract (such as his/her name, the company's name and account number in the database of the service aggregation web site), our approach offers the firm (in this case the utility company) the ability to extend its offering to online payment) to the ContactPoint user, in a way that is transparent to the user.

According to the present invention, the provider OccEntProv of occasional entitlement to the use of some site will negotiate means to reach the site for a collection of potential user, and then provide the means of reaching the site as reaction to some prompt delivered by some company that may be OccEntProv or some other company OC that uses some reaction enabling system such as ContactPoint. One may think of all cases as having OccEntProv and OC as separate entities, as the case when they are the same entity is then trivially simplified. When using the present invention, the access to a secure site may either seem easy to the end customer, who may not notice the site is restricted, or the end customer will knowingly using (possibly) temporary entitlement, depending of the choice of preferred embodiment.

The present invention may also be used to control access to special functions on a site whose access with limited function access is easily accessible. For instance, the site may serve both to advertise products and allow some users to order some products. Authorization and description of the type of orders an end user is entitled to can be distributed according to the present invention to facilitate the use of the order functions of the site.

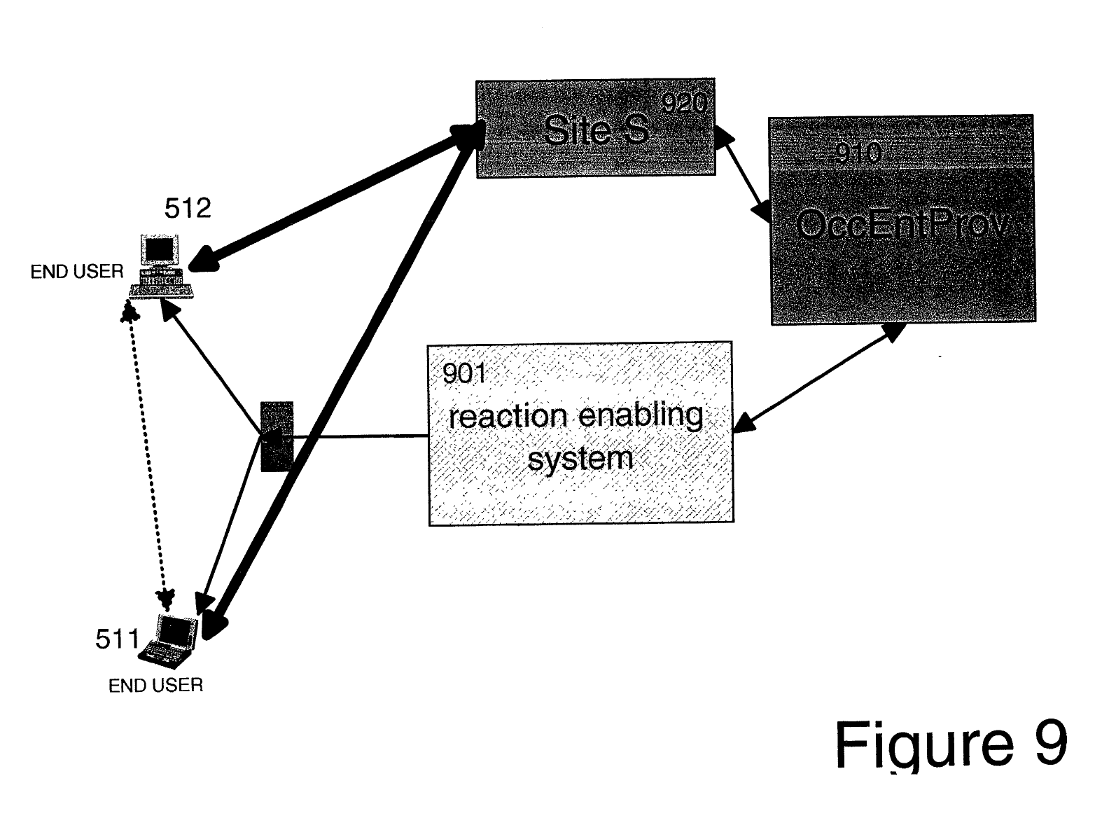

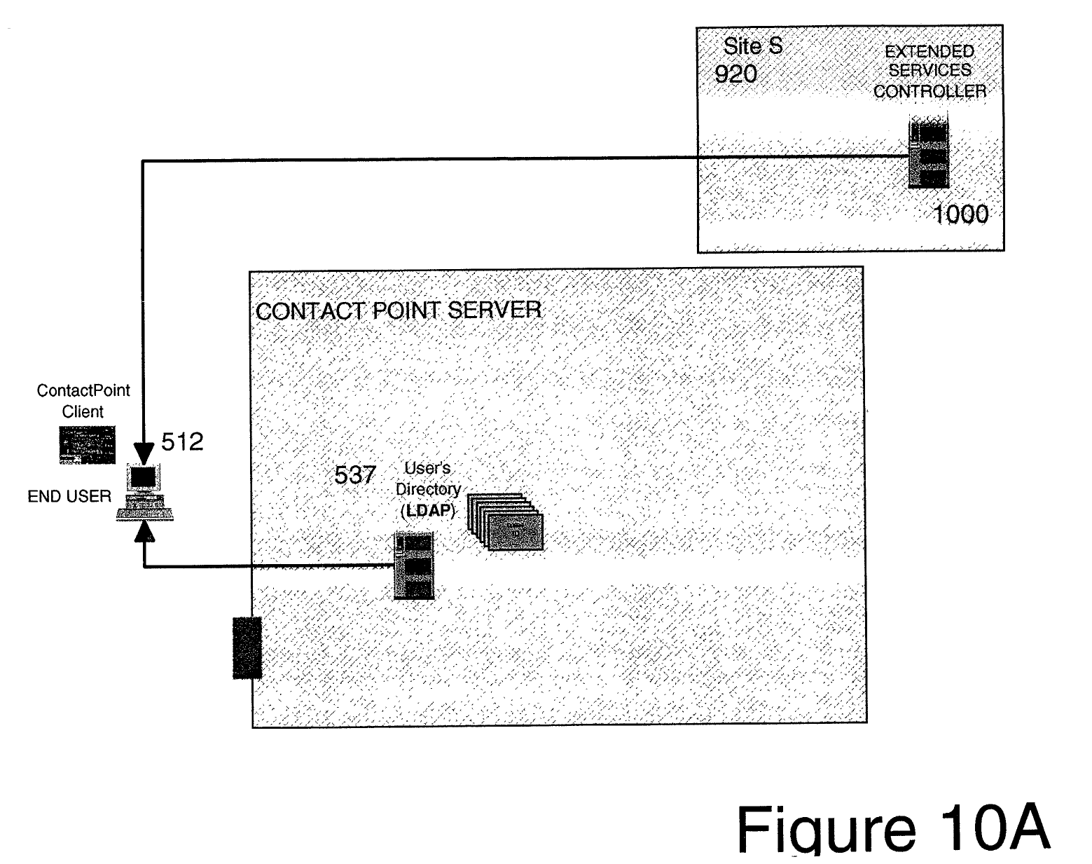

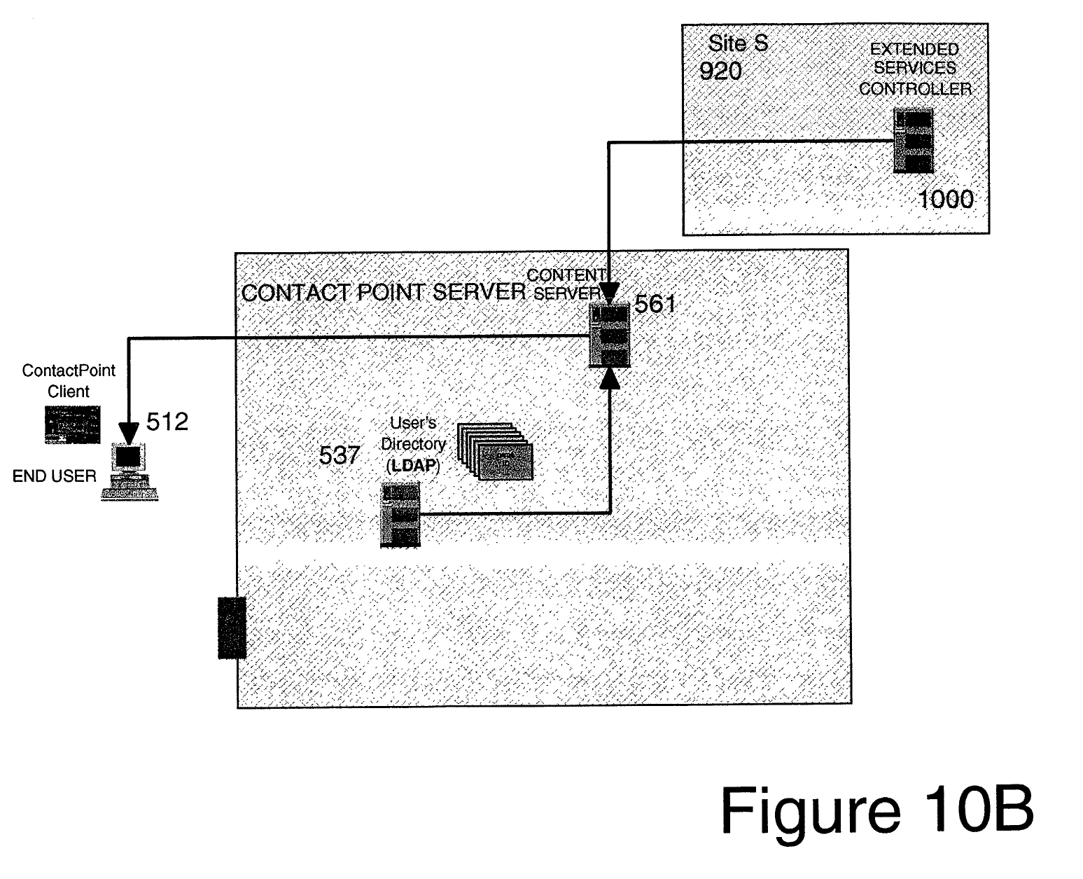

Turning now to FIGS. 9, 10A, and 10B, a detailed description of one preferred entitlement propagation use according to the present invention will be presented. The general simplified architecture of a reaction enabling system such as ContactPoint is as represented in FIG. 9, where the reaction enabling system 901 has links to the end users 511 and 512, and with OccEntProv at 910. OccEntProv also has relation with some secured site S at 920. The reaction enabling system 901, using its contract with 910, will give access to 920 to (some of) its end customers.

The provider OccEntProv of occasional entitlement to the use of site S will contact the site owner SO and negotiate occasional access for some potentially set of customers in several ways described, as follows.

OccEntProv will obtain (at some price, and/or for of contract) from SO that customers be given access rights, in the form of what we call an access codes, which may consists of passwords, and/or encryption software such as a digital signature. Any such access code AC will be recognizable by S as having (possibly) temporary use, and the contractual authorization will be preferably checked at any attempt to access S. S will preferably be able to detect from AC who is OccEntProv. This will allow one form of payment amount computation for the transaction between OccEntProv and SO. This will also allow SO to keep some statistics to verify the size of the contracts, and may give indication of some form of fraud.

In one embodiment, OC will distribute a version of AC to each end user EU through the reaction enabling system it owns, with the proper set of instruction on how to use AC. EU will then establish directly a connection with the site S. To avoid EU from forwarding access rights to other parties, several methods from computer and network security technology can be used, as well known in the art. For instance, AC will comprise an AC number which can be used only once.

In an alternative embodiment, OC will be the intermediary of all connections between EU and S. Then OC keep the AC of EU in its database, associated to EU's other data as much as laws on confidentiality allow in the country where the invention is used, for use when EU wants to connect with S, and easily controls, not only the access of EU (and the fact it is compatible with all relevant contracts), but also the precise nature of its entitlements. In this embodiment, OccEntProv will preferably negotiate with SO that OC has to reveal its own identity each time it creates an access to S for one of its own end customers, so that OccEntProv understands better how to charge OC.

In another alternative embodiment, OC gets from the negotiation between OccEntProv and OS, the right to host a replica of the data and services provided by S that the end customers of OC may use.

In all these embodiments, OC can clearly be OccEntProv itself, either for some or for all of the sites it wishes to make accessible to its end customers.

Different sites may accept deals with OccEntProv only if AC is used in one embodiment, so that several embodiments may have to be used in concurrence to access different sites.

FIG. 10A shows how the first embodiment can be implemented by giving the ContactPoint Client 512, a (possibly) temporary copy of the entitlement contract, preferably in most cases with a specific expiration date, that the client needs to present to the Extended Services Controller 1000 (the machine, human, or combination of them that controls all accesses to Site S at 920), at Site S 920 to receive the services he is entitled to.

FIG. 8B shows how the second embodiment and third embodiment can be implemented by having the Content Server 561, of ContactPoint Server proxy all request from the client to the Extended Services Controller 1000. When ContactPoint Client 512, needs to access a specific service, he sends the request Content Server 561, who will forward it to the Extended Services Controller 1000, on behalf of the ContactPoint client 512.

Some example applications/uses of the ContactPoint invention will now be presented that will illustrate the improvements of the invention over the prior art. These applications are not meant to be exhaustive, but should only be taken as illustration of the supplementary power offered by the new functionalities offered by ContactPoint.

When describing new products using ContactPoint, e.g., in a marketing application, one can also offer the end customer to get further information accessing for instance proper pages of the WWW, let him/her ask directly some question to clarify the characteristics of a new product, etc. . .

The access of the end customer to his/her account and to his/her personalized set of offered transactions (for instance a bill presentment and payment function in a banking application) can be through buttons on the ContactPoint window, which at the same time will announce new products, preferably chosen according to the profile of the customer. In this case the marketing function is secondary, from the end user perspective, as coming as a decoration to a window useful for its functionality.

The alert system will allow to inform the customer of important stock moves, or any news about any instrument or mutual fund known to be of interest to the customer, as in any alert system. In a financial application/capital market application, ContactPoint will furthermore offer means to access more complete information, allow to evaluate positions and strategies by pushing proper tools and accesses, and facilitate interaction with a broker or a financial analyst.

Also in the Capital Market arena, alerts can be propagated between, for instance a manager and his/her team of traders. The collaboration functions can then be used to organize very quickly a conference or video conference to discuss the issues and how to react to them. Some or all traders on a floor will be allowed to play the role of the System Administrator when needed, in a manner controlled by access control as regulated for instance by public key encryption and passwords. Different individuals authorized to the System Administrator function may have different priorities which will be handled as has been described previously for alerts and customers.

In an insurance application, the ContactPoint window can provide permanently means to report claims, at the same time as it will carry any CRM/Marketing function such as describing new products, wishing a happy birthday, or offering a bill presentment and payment function, either only for insurance bills, or in a more general context as presently several insurance companies want to become preferred overall financial partners.

In a procurement application buttons on the ContactPoint window will for instance give access to selected catalogues. The catalogs may contain order forms or these can be invoked independently, for instance to renew some regular order. Again in this case, the Marketing and pure alert functions may appear as secondary to the end user, even if they are essential in the ContactPoint server owner's strategy.

Having thus described our invention, what we claim as new and desire to secure by Letters Patent is as follows:

1. A business method for providing one or more alerts over an network, the business method comprising the steps of:
composing one or more alert messages, which are sent to an alert database;
gathering one or more reaction enabling tools for a user to use to respond to the respective alert;
using data extracted from one or more databases, including the alert database, to dispatch the alert messages and corresponding reaction enabling tools to one or more of the clients over a network, the alert messages and corresponding reaction enabling tools that allow contact the facilities useful in responding to the alert.

2. A business method, as in claim 1, where the tool gathering is done by any one or more of the following: a manual process, an automatic process, and a combination of a manual and automatic process.

3. A business method, as in claim 1, where the content of the alert messages include any one or more of the following: a sales advertising, a new product announcement, a new service offering, a catastrophic or beneficial price change, a research report, technical information, a product warning, the answer to a question, schedule information about events and people, educational materials, and a news event.

4. A business method, as in claim 1, where what identifies an event that will be all or part of the content of an alert message is any one or more of the following: a automatic trigger, a trigger based on a numeric value, a pricing trigger, a pricing trigger that is provided by the client, a news event, a logical combination of events, and a human decision.

5. A business method, as in claim 1, further comprising the step of associating one or more of the response enabling tools to alerts by use of any one or more of the following response enabling tools: a standard set of tools related to a standard set of alerts, defined subsets of these sets of tools which constitute coherent sets of tools, access to a customer database, and one or more interpretations of one or more database.

6. A business method, as in claim 1, where the response enabling tools include any one or more of the following: a link to one or more web pages with clearance to appropriate services from these pages, a result of one or more searches, a document with relevant data, an access to search engines, one or more packages of algorithms allowing pricing of financial instrument, a statistical analysis, a portfolio optimization, simulation tools, one or more dictionaries, an automatic machine translation, access to natural language agents, a chat link to an expert, an audio link to an expert, an audio-video link to an expert, document sharing tools, access to other members of some virtual community, an access to transactions, an access to orders, and an access to a catalog.

7. A business method, as in claim 1, where one of the databases is a database of client information.

8. A business method, as in claim 7, where the response enabling tools are determine by the alert and a combination of the user information.

9. A business method, as in claim 7, where the user information includes any one or more of the following: a user profile, a set of preferences for each user determined directly by the user, a set of preferences defined by a price paid for the service, a valuatiion of the user, a set of one or more priorities for each user, a set of one or more priorities for one or more user depending on a nature of the alerts.

10. A business method, as in claim 1, that further comprises the step of providing to the users means to easily get access to otherwise protected service on a temporary basis to respond to the alert.

11. A business method, as in claim 10, where the protected service is any one or more of the following: an exclusive service, an access to a web site, and an access to privileged information.

12. A business method, as in claim 1, where the client includes any one or more of the following: a web site and a person.

13. A business method, as in claim 1, where the response tools include any one or more of the following: connection to a multiple reaction system and connection to a collaboration system.
